(19) United States
(12) Patent Application Publication
(10) Pub. No.: US 2011/0111381 A1
(43) Pub. Date: May 12, 2011

(54) METHOD AND SOFTWARE FOR INTERACTIVE LEARNING OF ENGINEERING STATICS

(75) Inventors: Ambar K. Mitra, Ames, IA (US); Abhijit Chandra, Ames, IA (US); Craig D. Herreman, Tucson, AZ (US); Joel P. Dunham, Cascade, MT (US); Robert E. Harris, Ankeny, IA (US); Dipayan Mitra, Ames, IA (US)

(73) Assignee: ACTUS POTENTIA, INC., Ames, IA (US)

(21) Appl. No.: 13/004,010

(22) Filed: Jan. 10, 2011

Related U.S. Application Data
(63) Continuation of application No. 11/626,344, filed on Jan. 23, 2007, now abandoned.
(60) Provisional application No. 60/762,053, filed on Jan. 24, 2006.

(51) Int. Cl. G09B 23/08

(52) U.S. Cl. 434/302

(57) ABSTRACT

The present invention provides a computer-implemented method of problem solving that includes graphically displaying a plurality of concepts, dynamic links between the concepts, and solving a problem based on the displayed concepts and dynamic links. Other embodiments include: a computer-readable medium having instructions thereon for causing a suitably programmed information-processing apparatus to perform a method of the problem solving that includes graphically displaying a plurality of concepts, displaying dynamic links between the concepts, and solving a problem based on the displayed concepts and dynamic links. Still other embodiments include a computerized apparatus that includes a display output unit, a display drive unit that causes a plurality of concepts to be displayed on the display unit, and that causes dynamic links between the concepts to be displayed, and a solution unit that solves a problem based on the displayed concepts and dynamic links, and that displays the solution.

### CROSS-REFERENCE TO RELATED APPLICATIONS

This invention is a continuation application of U.S. patent application Ser. No. 11/626,344 filed on Jan. 23, 2007, titled “SOFTWARE AND METHOD FOR INTERACTIVE LEARNING OF ENGINEERING STATICS”, which claims benefit of U.S. Provisional Patent Application No. 60/762,053 filed on Jan. 24, 2006, titled “SOFTWARE AND METHOD FOR INTERACTIVE LEARNING OF ENGINEERING STATICS”, each of which is incorporated herein by reference in its entirety. This invention is also related to commonly owned U.S. patent application Ser. No. 11/259,171 titled “System and Method for Learning Intervention through Dynamic/Interactive Concept-Mapping” filed Oct. 25, 2005, which is incorporated herein by reference.

### FIELD OF THE INVENTION

This invention relates to the field of engineering education, and more specifically to a software and method for interactive learning and teaching of Engineering Statics through a self-paced, interactive environment that provides immediate feedback to students in the form of hints and correctness for the solution of engineering problems.

### BACKGROUND OF THE INVENTION

Conventional engineering education, particularly for engineering statics, has been rigid and not as effective as it could be in transferring knowledge, understanding, and capability to students and engineers.

### BRIEF SUMMARY OF THE INVENTION

Traditionally, learning has been understood as a process of acquisition of knowledge, retention of that knowledge, and reproduction of that knowledge at a later date in nearly the same form as it was originally acquired. In the modern view of learning, a new component is added to the definition of learning—which is transfer. This involves the transferring of knowledge to new situations in a way that facilitates innovation, discovery, and design (see references Mayer and Wittrock 1996, Bransford et al. 1999, Haskell 2001, listed below). It has been observed that learning activities that promote retention are easy to construct, whereas, promoting transfer is a difficult task (Mayer 2002).

In a classroom, the students are trained in transfer through problem solving. Problem solving involves the identification of a start-point and an endpoint, the searching of a path that connects these two points, and the recognition of the existence of multiple intermediate points on the path. In order to create the path that solves a problem, a student must utilize the five following processes.

C1—Understand the individual physical principle/law

C2—Be comfortable with the inter-connection and association among the laws

C3—Evaluate the cost/effort involved in a chosen path

C4—Analyze the feasibility of a path.

C5—Create the path and execute the mathematical operations.

The objective of the invention is to supplement classroom instruction with the following goals:

Facilitate transfer of knowledge

Stimulate four cognitive processes C2 through C5

Facilitate problem solving, meaningful learning, and longer retention

Encourage innovation through knowledge transfer

The intervention will be used parallel to classroom instruction during problem-solving sessions. Therefore, no change in curriculum or lecturing style is necessary.

During problem sessions, the students can receive self-paced instruction from the software without any personal help from the instructor. The software will act as a private tutor or teaching assistant and will help students in completing their homework. Many students become disenchanted with lack of success; the software will make students successful and keep students motivated in the learning process. The software is expected to create an exciting learning environment and as the students begin to explore the contents of the course in depth they will remain eager learners.

### Comparison with Other Software

The methodology and description of the software Free Body Diagram Assistant (FBDA) has been reported by Roseli et al. 2002 (see Roseli, R. J., Cinnamon, B., Norris, P., Brophy, S. P., Eggers, D., Brock, J., 2002, Development of an interactive free body diagram assistant for biomechanics, Proceedings of the 2nd Joint EMBS/BMES Conference, Houston, Tex.). This FBDA software has an authoring system in which the designer creates a problem by selecting a picture from a collection. The problem is then included in a lesson. The students login to the lesson and create a solution to the problem in the lesson. The software then compares the designer's solution with the students' solutions.

The software named “Physics 101SE” from Praeter Software also operates from a problem bank of finite size.

Another software named “Best Statics” delivered through a web-site also operates from a problem bank of finite size.

In contrast, the present software does not operate from a collection of problems. Therefore, students can learn problem-solving techniques by exploring an unlimited number of problems. Students can design problems of their own choice or get a problem from a textbook and get assistance in problem-solving technique from the software.

### BRIEF DESCRIPTION OF THE DRAWINGS

FIG. 1 is a presentation slide of a contents page of lecture notes from a Microsoft® Office PowerPoint® presentation-software presentation.

FIG. 2 is a presentation slide of a sample page of lecture notes from a Microsoft® Office PowerPoint® presentation-software_presentation.

FIG. 3 is a screen shot of a screen showing the options of force problems.

FIG. 4 is a screen shot of a screen showing the options of moment problems.

FIG. 5 is a screen shot of the problem-solving page for couple.

FIG. 6 is a screen shot of the problem-solving page for direction cosines.

FIG. 7 is a screen shot of the direction cosine screen for properly posed problems.

FIG. 8 is a screen shot of the direction cosine screen for improperly posed problems.

FIG. 9 is a screen shot of a screen defining the shape and size of an area for property calculation.

FIG. 10 is a screen shot of a screen showing selected area for property calculation.

FIG. 11 is a screen shot of a screen showing the area properties.

FIG. 12 is a screen shot of a beginning screen for Shear and Bending Moment.

FIG. 13 is a screen shot of a screen for setting up beam supports.

FIG. 14 is a screen shot of a screen for adding loading on the beam.

FIG. 15 is a screen shot of a screen showing the definition of a beam problem.

FIG. 16 is a screen shot of a screen for entering support reactions.

FIG. 17 is a screen shot of a screen for entering loading discontinuities.

FIG. 18 is a screen shot of a screen for entering maximum and minimum values of shear force.

FIG. 19 is a screen shot of a screen showing the plot of shear force along the beam.

FIG. 20 is a screen shot of a screen showing the plot of bending moment along the beam.

FIG. 21 is a screen shot of a starting screen for free-body diagram.

FIG. 22 is a screen shot of a screen showing basic structural members.

FIG. 23 is a screen shot of a screen showing pin-joined members and types of support.

FIG. 24 is a screen shot of a screen showing special structural elements, e.g., pulley, wheel, clamped beam.

FIG. 25 is a screen shot of a screen showing a structure built by using the elements.

FIG. 26 is a screen shot of a screen showing point force.

FIG. 27 is a screen shot of a screen showing distributed force.

FIG. 28 is a screen shot of a screen showing point moment.

FIG. 29 is a screen shot of a screen showing a loaded frame.

FIG. 30 is a screen shot of a screen showing the free-body-diagram of whole structure and tabs for individual members.

FIG. 31 is a screen shot of a screen showing the free-body-diagram of a member.

FIG. 32 is a screen shot of a screen showing free-body-diagrams of pins.

FIG. 33 is a screen shot of a screen showing solution strategy.

FIG. 34 is a screen shot of a screen showing a successful solution step.

FIG. 35 is a screen shot of a screen showing an unsuccessful solution step.

FIG. 36 is a screen shot of a screen showing the computer solution of the free-body-diagram problem.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component that appears in multiple Figures. Signals and connections may be referred to by the same reference number or label, and the actual meaning will be clear from its use in the context of the description.

### Description of Software

In some embodiments, the software includes five parts. One part includes lecture notes included as a Microsoft® Office PowerPoint® presentation-software presentation. The four other parts are interactive software for assistance in problem solving written, in some embodiments, on a VisualBasic.Net (Visual Basic® is a registered trademark of MICROSOFT® Corporation) platform. The description of these five parts follows:

### Part-1

### The Lecture Notes

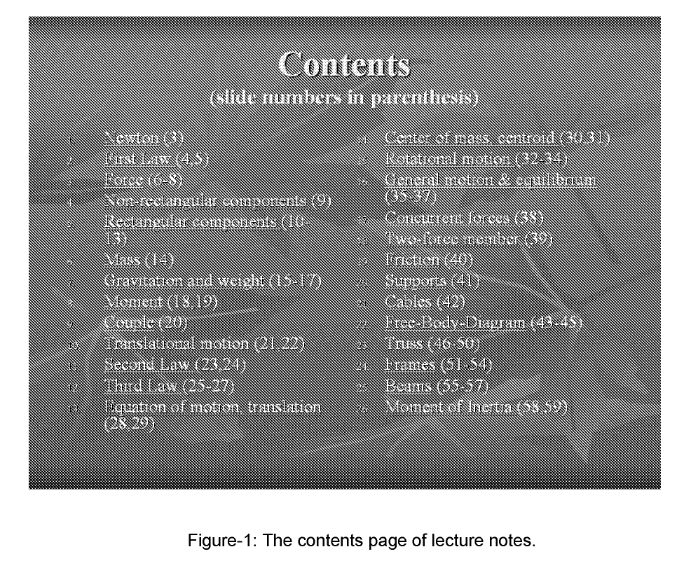

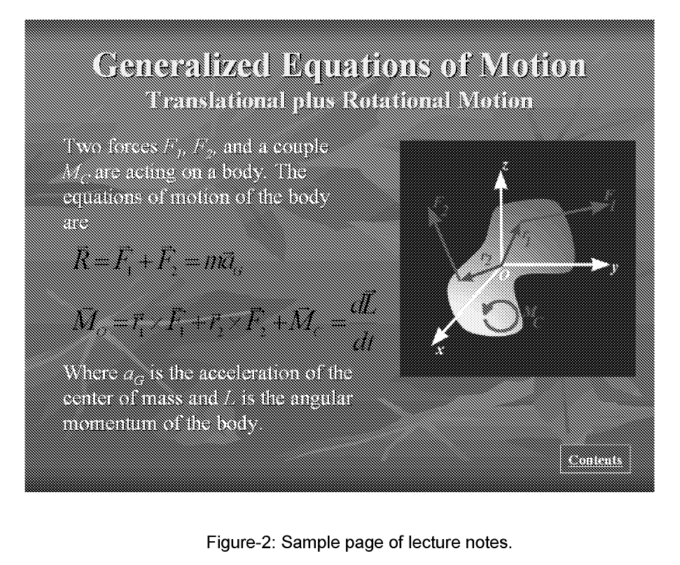

The lecture notes contain important ideas, concepts, and equations that are usually a part of an Engineering Statics course. In FIG. 1, the contents page of the lecture notes is shown. A sample page of the presentation is show in FIG. 2.

### Part-2

### Force-Moment-Couple

This part of the software deals with the basic ideas of force, moment, and couple. From the start page of this part of the software, the user chooses one of the three options—(i) force, (ii) moment, and (iii) couple.

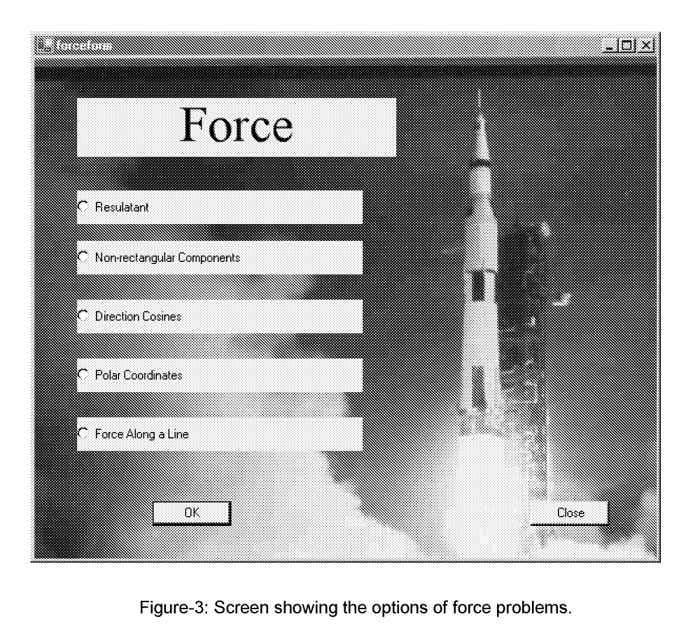

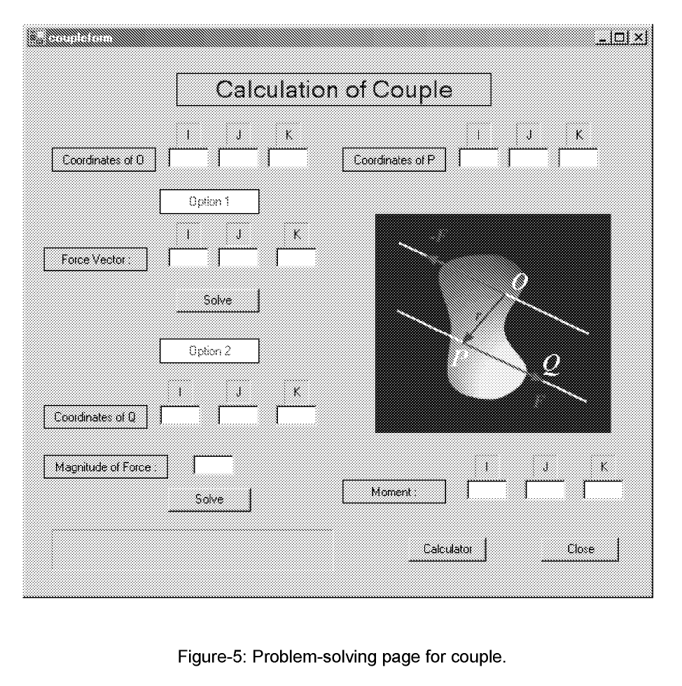

By selecting any one of these options, the user can open a corresponding window. The windows for force, moment, and couple are shown in FIGS. 3, 4, and 5, respectively.

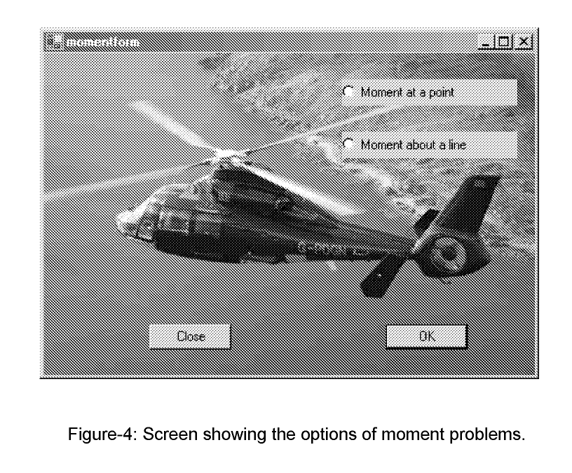

On the force and moment windows, of FIGS. 3 and 4, there are radio buttons corresponding to various types of problems involving the calculation of force and moment. The set-up of only one out of many windows is included here for demonstration.

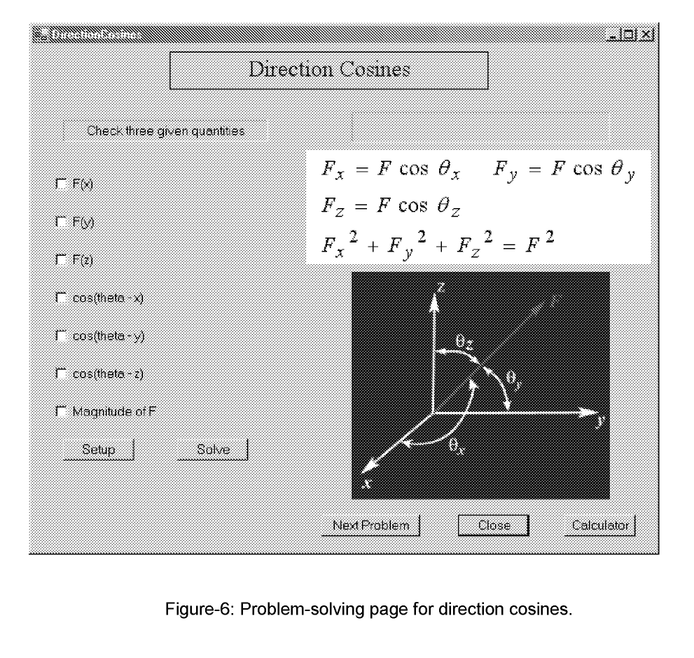

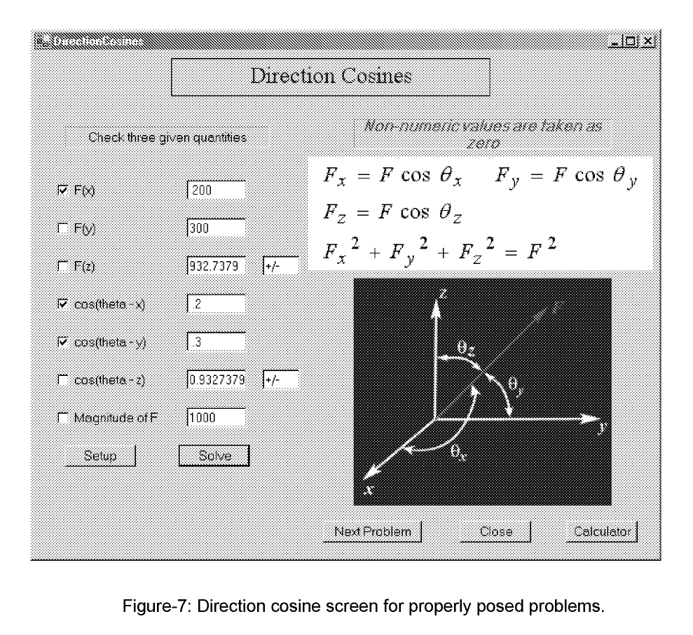

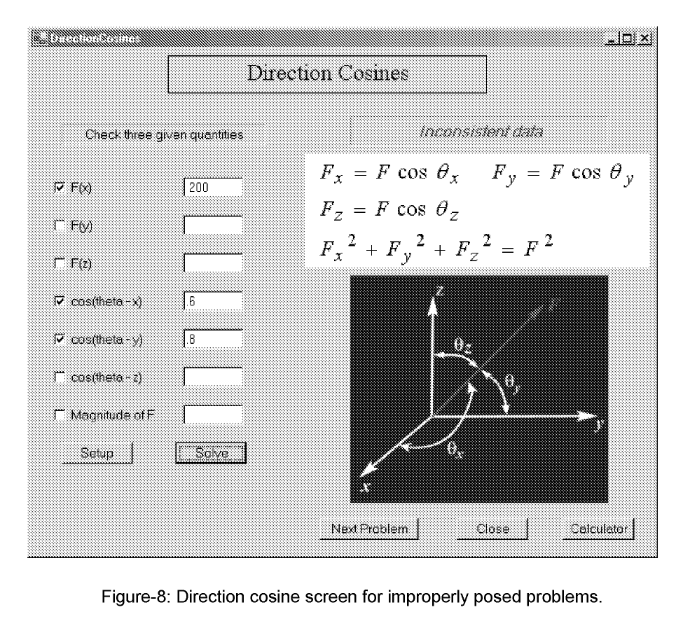

The screen for force calculations involving “Direction Cosines” is shown in FIG. 6. This screen shows the relevant equations, the relevant diagram, and other buttons and text-entry windows for setting up a problem involving the concept of direction cosines. This type of problem contains four equations and seven variables. Thus, at most three variables can be specified for the solution. When a problem is properly posed, the solution screen appears as shown in FIG. 7. This screen shows that the software can identify situations with multiple solutions and designate such solutions with the (+/−) sign. For improperly posed problems, the solution screen appears with a warning message as shown in FIG. 8.

### Part-3

### Area Properties

This part of the software deals with the calculation of properties of plane areas. The properties include: area, location of centroid, and moments and product of inertia. The calculations involving parallel and rotated axis theorems are also included.

Firstly, the user defines the size of the plane area by entering the maximum and minimum values of the abscissa and the ordinate, i.e., (xmin, xmax) and (ymin, ymax). The user then defines the shape of the area by inserting equations of the type

y=f₁(x), y=f₂(x), . . . , y=fₙ(x)

x=g₁(y), x=g₂(y), . . . , x=gₘ(y)

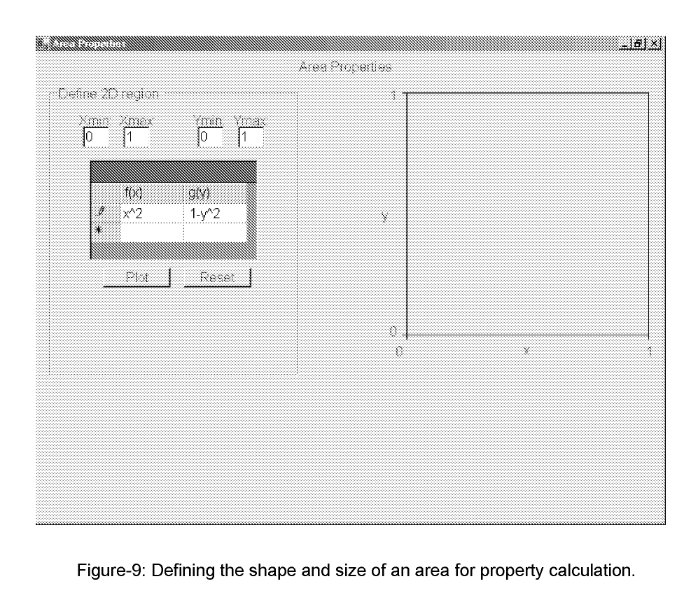

The screen of FIG. 9 shows the domain size and the equations of a problem.

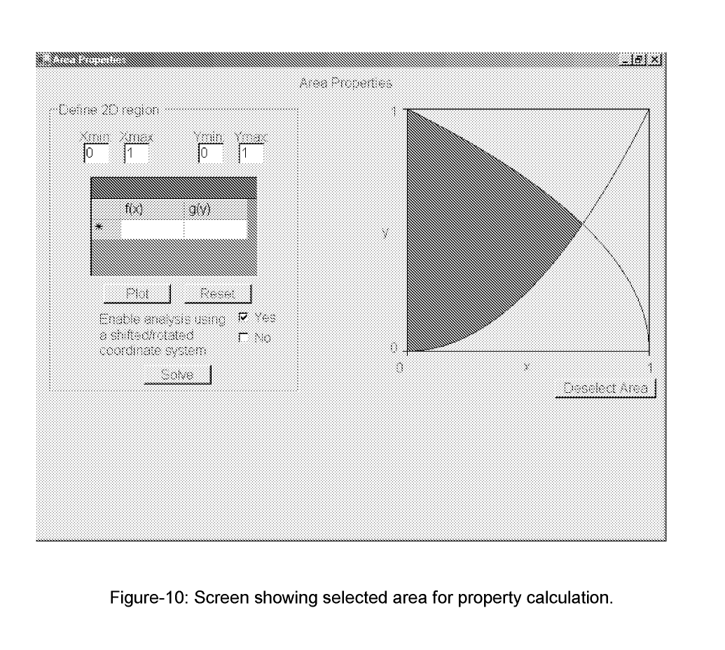

The user can then plot the curves corresponding to the equations and select an enclosed area. The curves and the selected area are shown in the screen of FIG. 10.

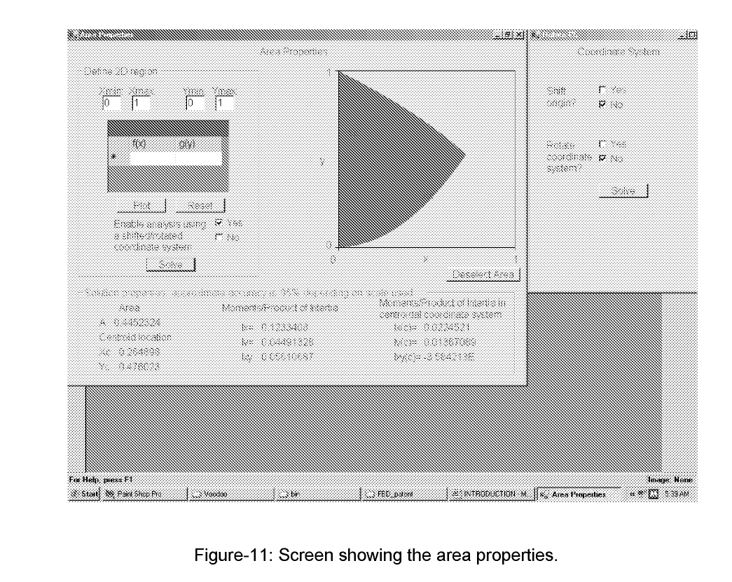

By clicking on the “solve” button the user obtains the area properties for the chosen area, as shown in FIG. 11. The user also gets an additional screen on the right for entering the location of the shifted origin and angle of rotation of the coordinate system. The software calculates and displays the moments and product of inertia in the shifted and rotated system. Through this exercise the user learns the use of the Parallel Axis and the Rotated Axis Theorems.

### Part-4

### Shear and Bending Moment Diagrams

A structural member that is loaded in a direction perpendicular to its long dimension is a beam. The flexural stress and the shear stress at a section of the beam depend on the local shear force (V) and bending moment (M). The stresses are at a maximum where V and/or M are at maximums. The easiest way to locate these maximums is to plot V and M along the length of the beam. These plots are known as the shear and bending-moment diagrams. In some embodiments, the present invention utilizes the well-known classical mathematical technique called the Singularity Function method to solve such problems.

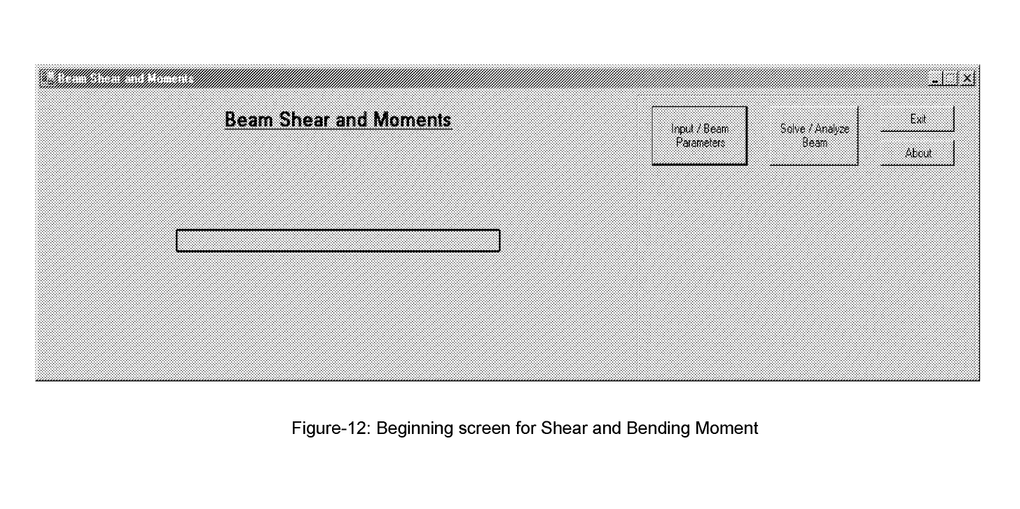

This part of the software assists students in drawing shear and bending-moment diagrams by guiding them through the steps of the procedure. The beginning screen is shown in FIG. 12. On this screen, the user can set-up various kinds of determinate or indeterminate beam problems by clicking on the “Input Beam Parameters” button. The sketch of the problem is displayed on the left-hand-side of this screen. Then the user can get guidance in analyzing the problems by clicking on the “Solve Analyze Beam” button.

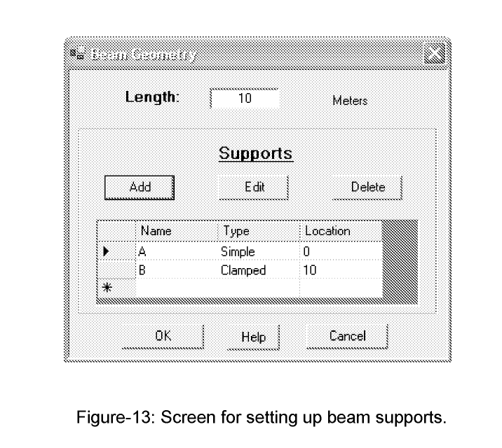

The first step in setting up the beam problem is adding the supports for the beam. The screen for this step is shown in FIG. 13. On this screen the user first enters the length of the beam and then can choose the type of the support, e.g., simple support or clamped support. The user also enters the location of the supports.

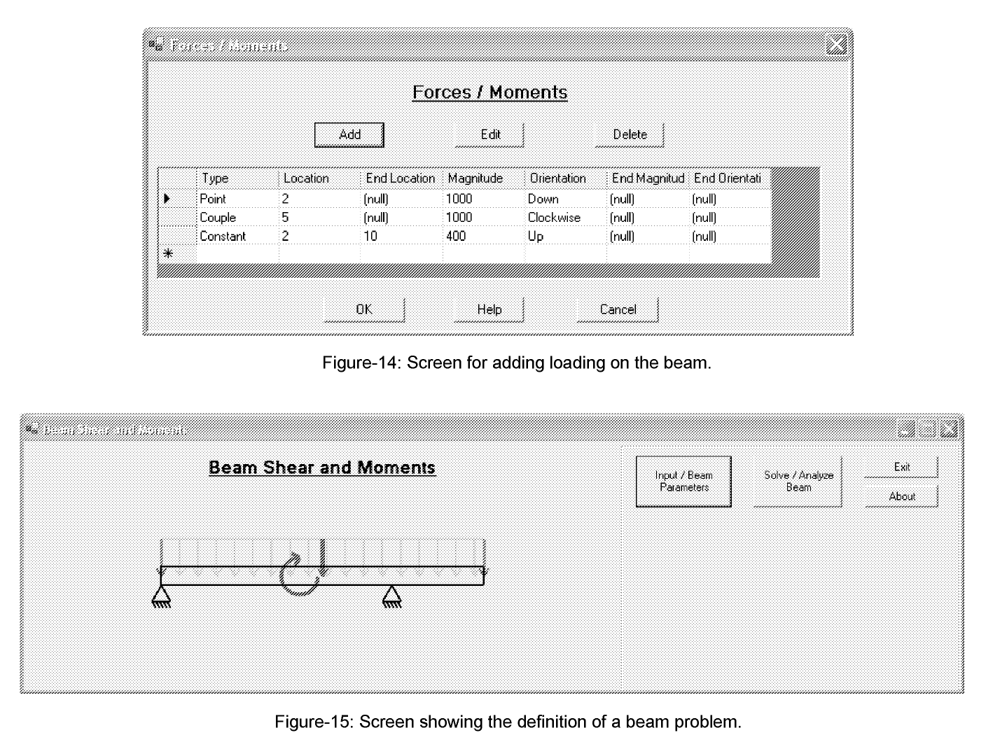

The user can apply the loading on the beam from the screen shown in FIG. 14. The user has the option of applying various types of loading, e.g., point load, point moment, and constant distributed loading. The user can fix the location of these loading and also the direction of this loading—up/down for forces and clockwise/counter-clockwise for moments.

The definition screen for a beam problem is shown in FIG. 15. When the user clicks the “Analyze” button, the software guides the user through the steps of solving drawing the shear and bending moment diagrams.

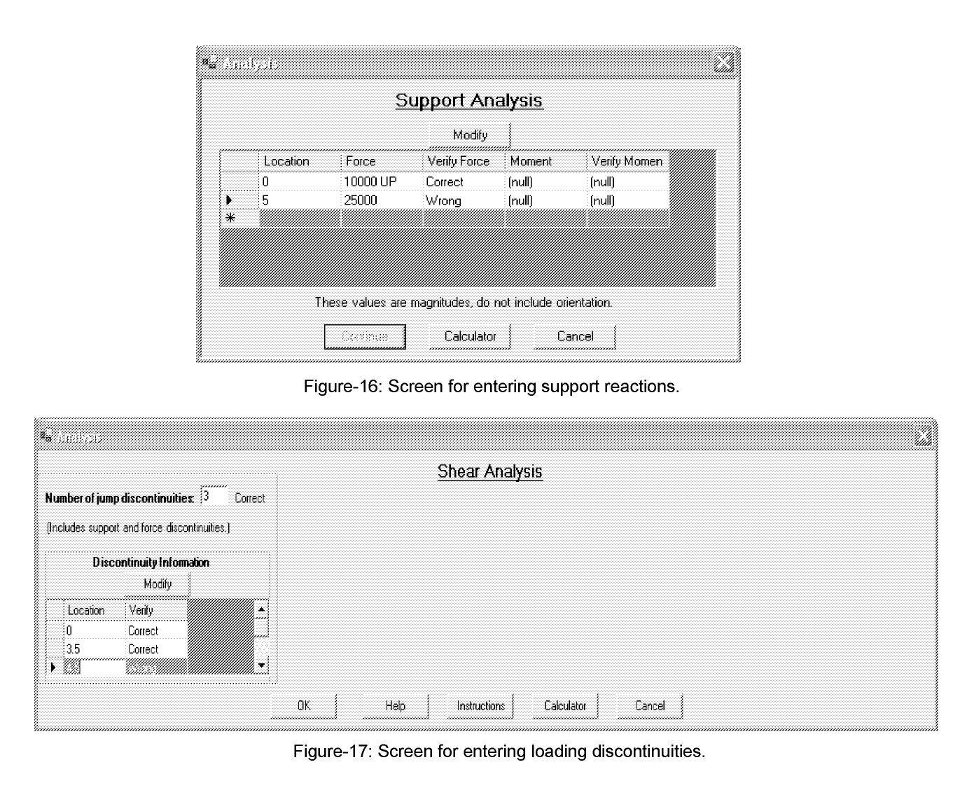

The first step in a beam analysis is to compute the support reactions. The user enters the values of the support reactions in the screen of FIG. 16. The software responds the user with “correct” or “wrong” as shown in FIG. 16. Only when all user entries are correct, the software allows the user to proceed to the next screen.

The following screen is shown in FIG. 17. On this screen the user is asked to enter the locations of discontinuities in the force-loading. The software responds to the user with “correct” or “wrong” as shown in FIG. 17. Only when all user entries are correct, the software allows the user to proceed to the next screen.

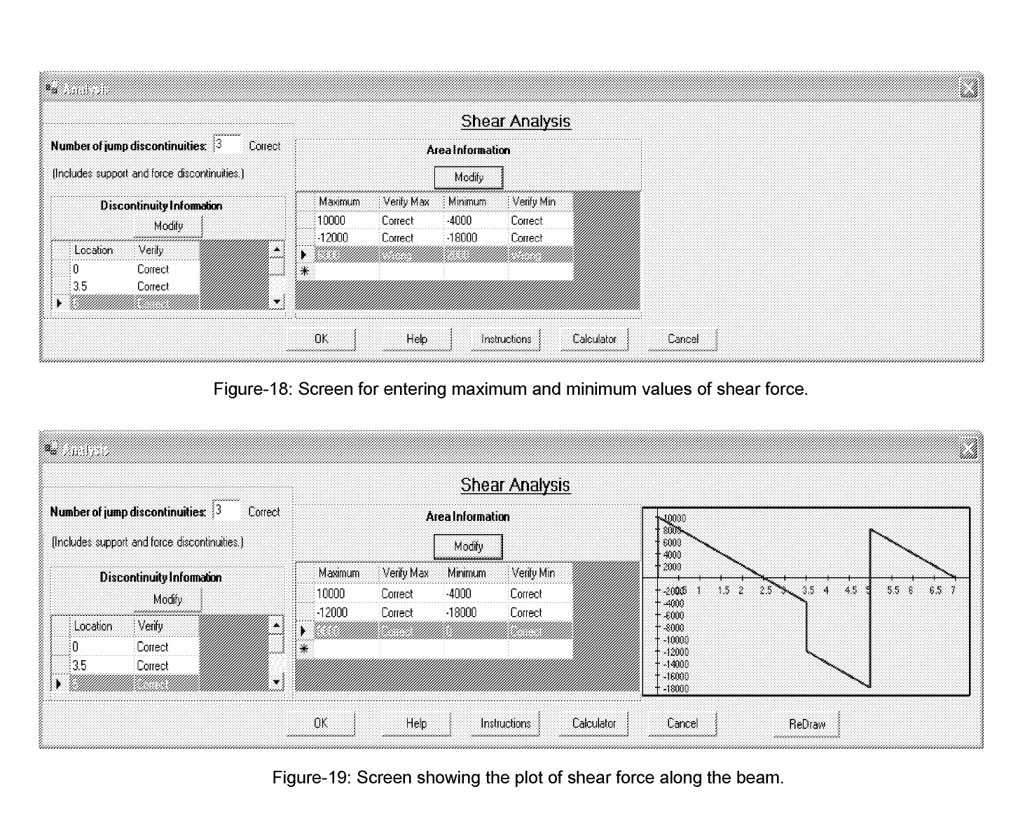

The loading discontinuities partition the beam into segments. These segments are shown in the screen of FIG. 18. On this screen the user is required to enter the maximum and minimum values of the shear-force in each segment. The software responds to the user with “correct” or “wrong” as shown in FIG. 18. Only when all user entries are correct, the software draws the shear diagram, as shown in FIG. 19.

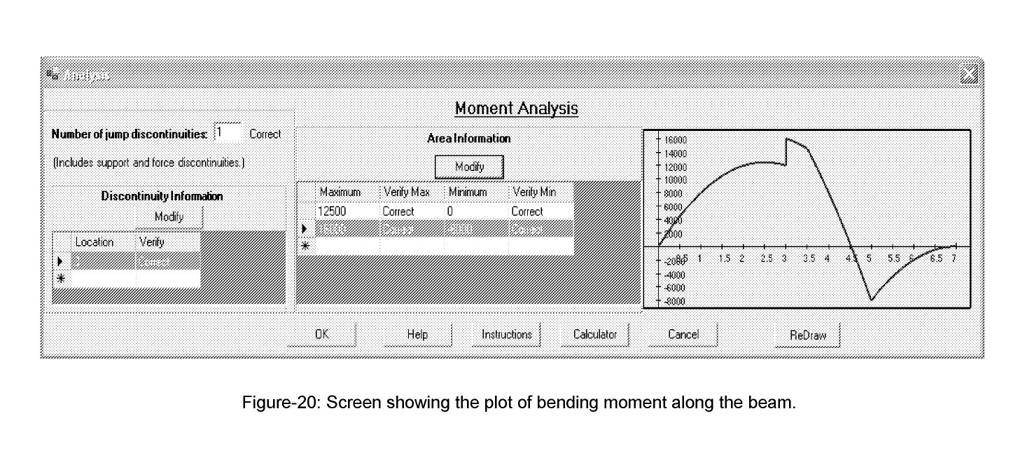

The steps for drawing the plot for bending moment are very similar. The final screen for bending moment is shown in FIG. 20.

### Part-5

### Free-Body-Diagrams

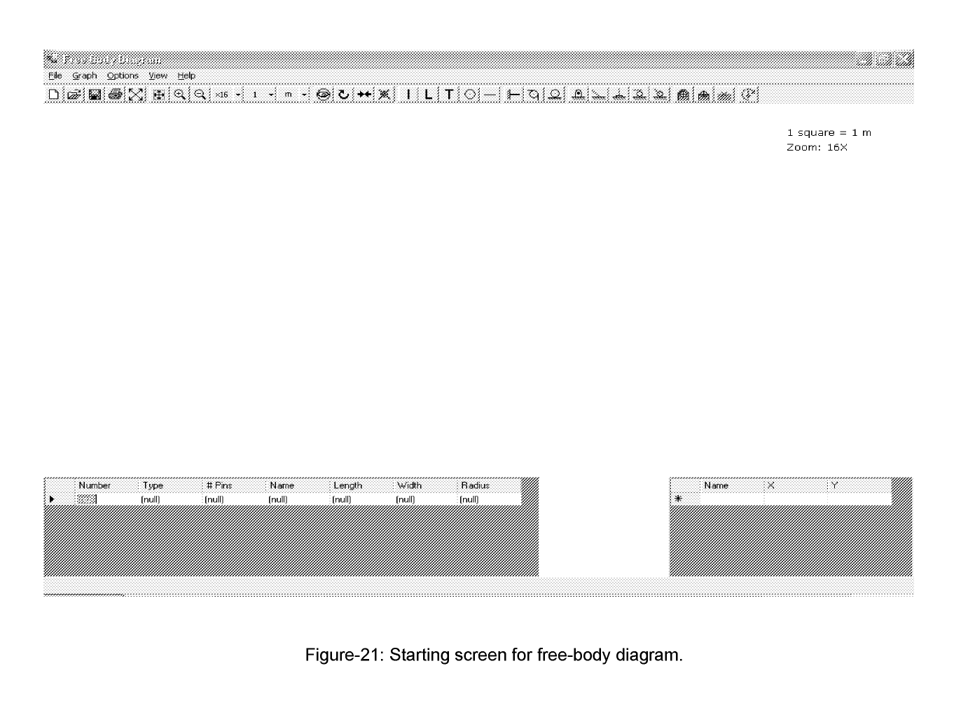

This part of the software assists the user in building and analyzing frames and trusses. The beginning screen is shown in FIG. 21. The screen has a toolbar at the top and a workspace. The toolbar contains buttons for structural elements and for editing and analyzing. The analysis is designed following the algorithm described in the patent application “System and Method for Learning Intervention through Dynamic/Interactive Concept-Mapping”, which is U.S. patent application Ser. No. 11/259,171 and which is incorporated herein by reference.

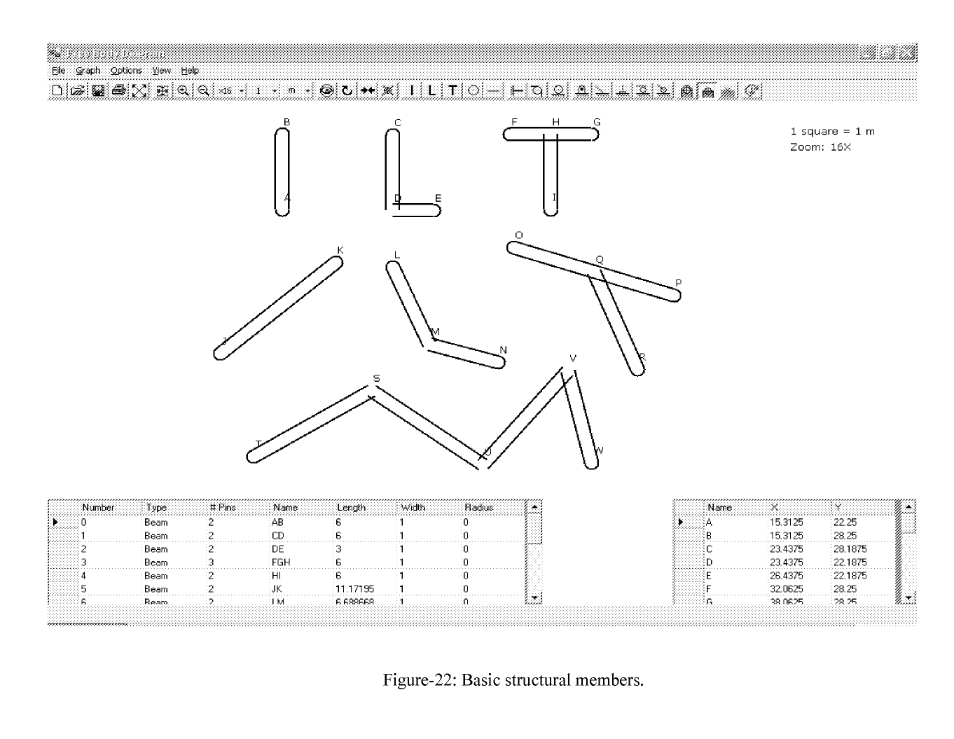

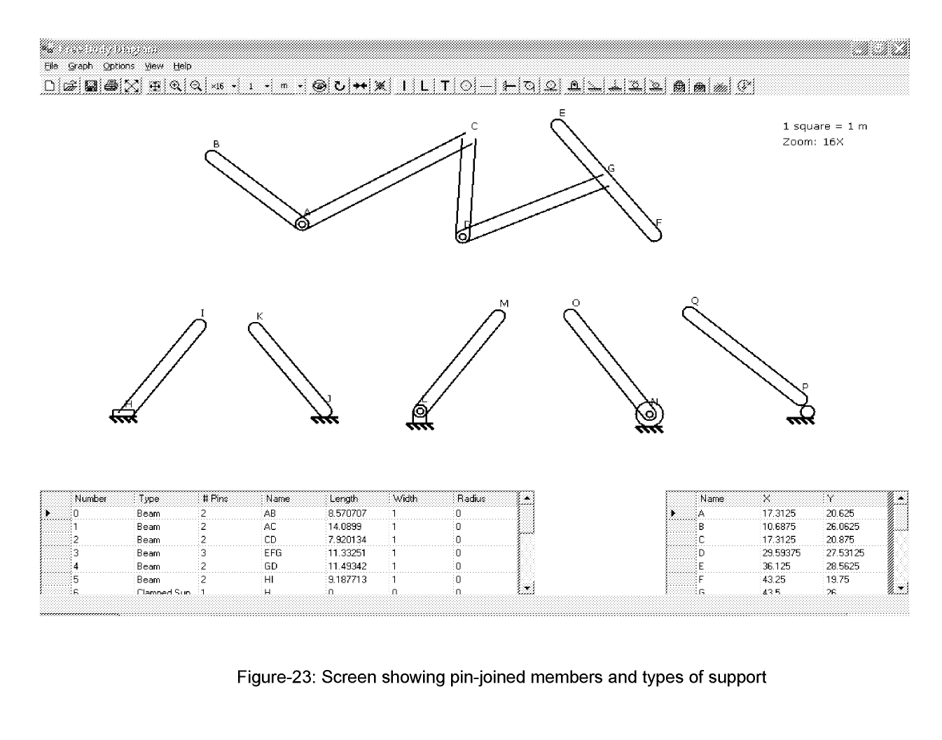

Among the structural elements are the I-member, L-member, and T-member. These are shown in the first row in the screen of FIG. 22. These structural members can be distorted or inclined by dragging them with the mouse as shown in the second row of FIG. 22. Furthermore, members of complex shape can be built by taking several I-members and welding them together, as shown in the third row of FIG. 22. The structural members can be joined with pins as shown in the first row of FIG. 23. In the second row of FIG. 23 are shown the various ways of supporting a member, e.g., clamp support, contact support, pin support, and roller support.

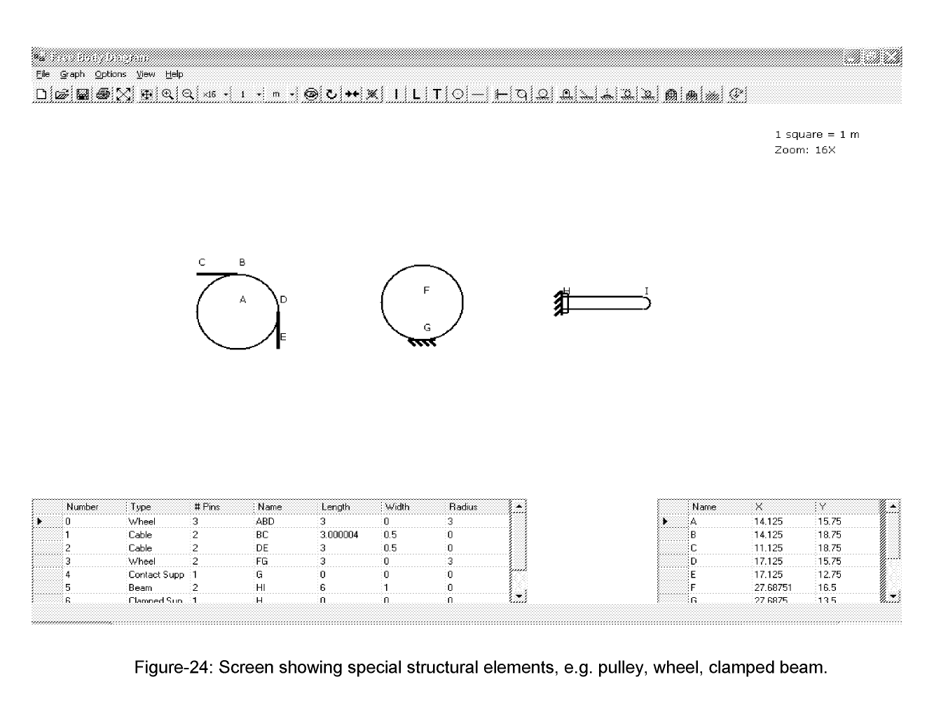

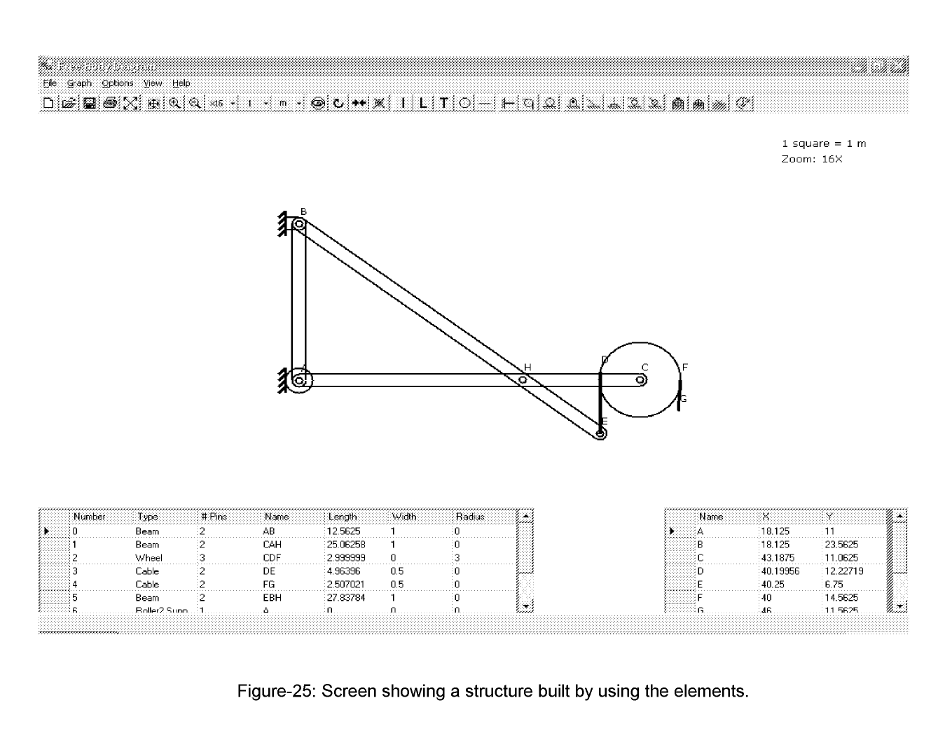

The screen of FIG. 24 shows special structural elements, e.g., pulley, wheel, and clamped beam. The screen of FIG. 25 shows a frame built by utilizing the structural elements and the supports.

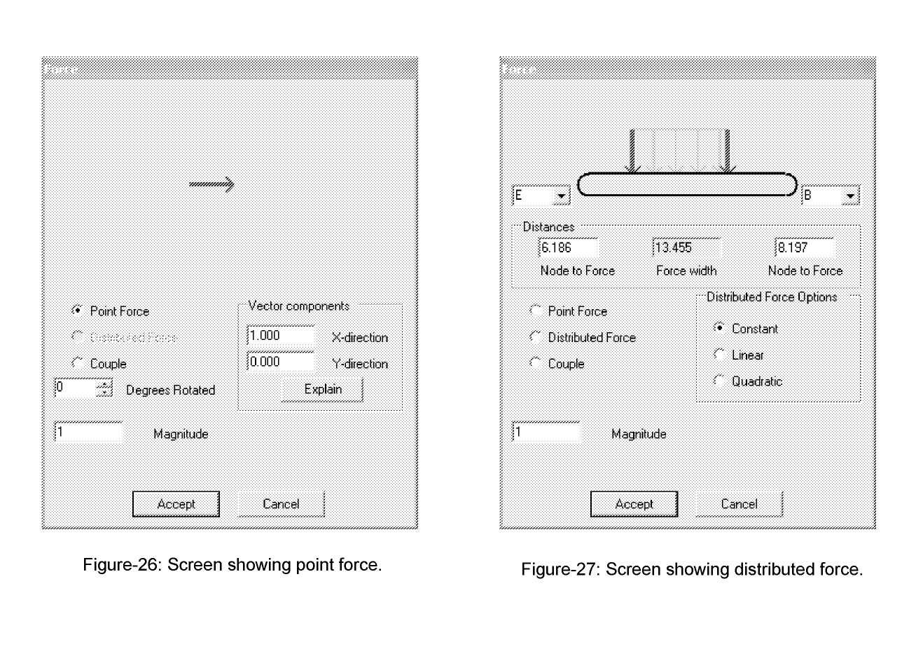

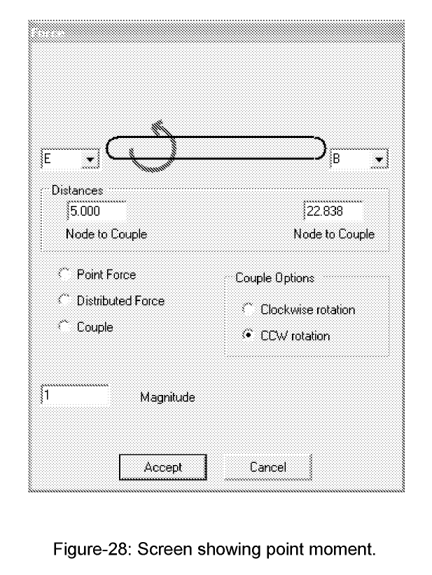

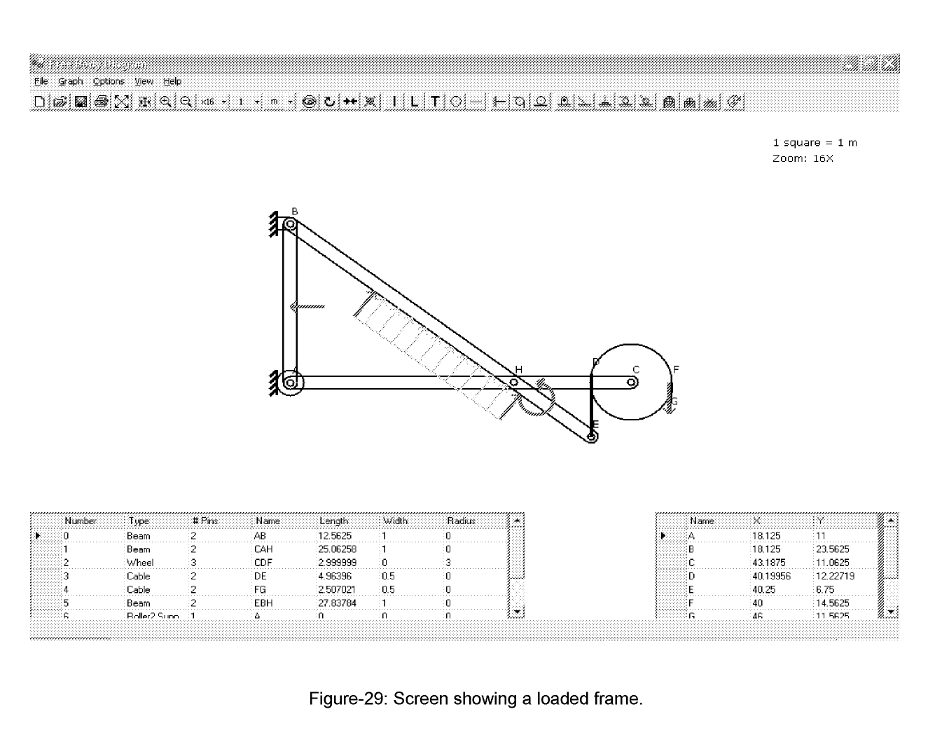

The loadings on the structure can be applied by using the point-force screen of FIG. 26, the distributed-load screen of FIG. 27, and the point-moment screen of FIG. 28. The loaded structure is shown in FIG. 29.

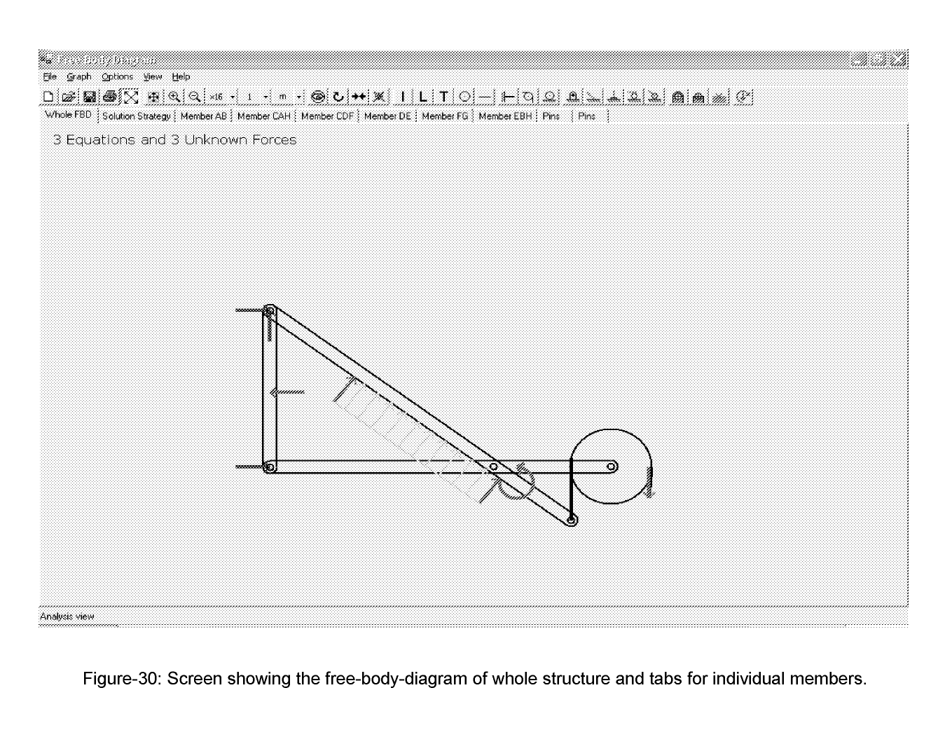

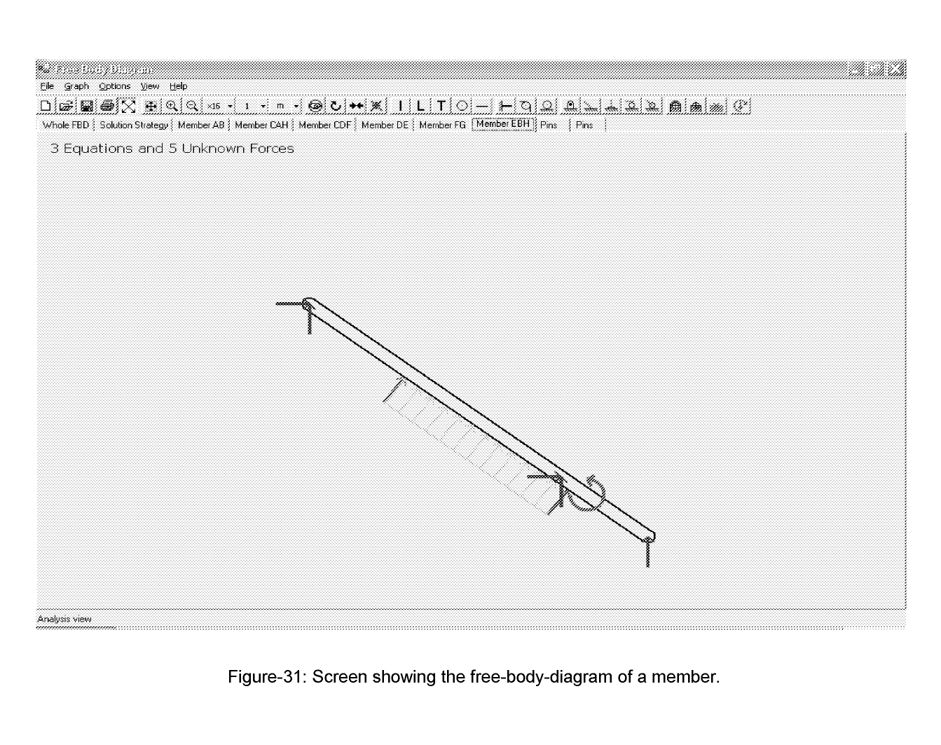

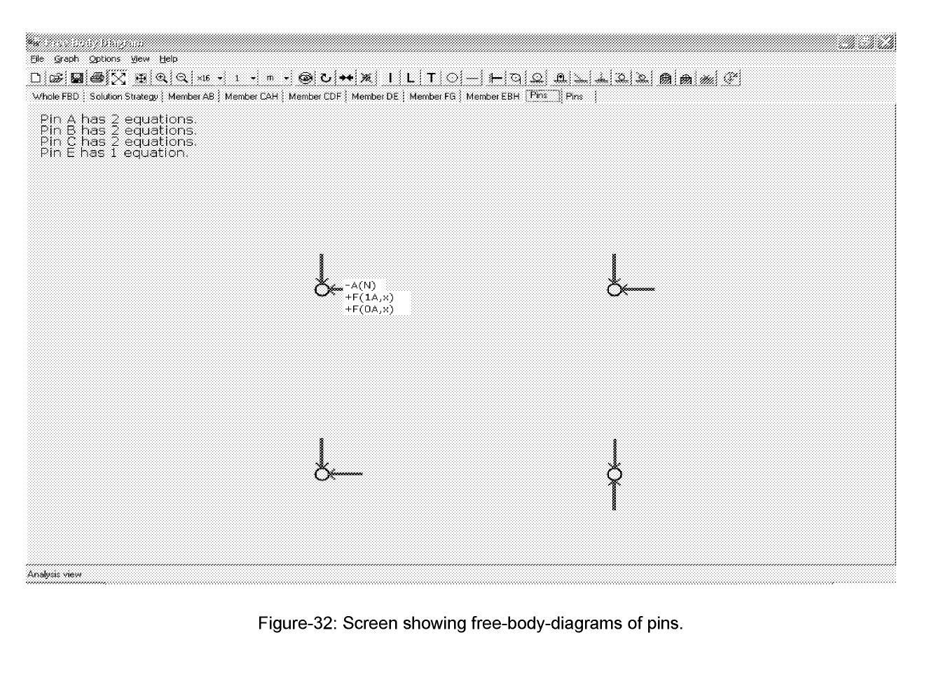

When the user clicks on the “Explode” button, the free-body-diagram of FIG. 30 appears. This screen has several tabs just below the tool bar along the top of the screen. Each tab shows a free-body-diagram, either of the whole structure or any member in the structure. Two such screens are shown in FIGS. 31 and 32. FIG. 31 shows a member and FIG. 32 shows four pins. The force designation corresponding to the force arrows are also shown in FIG. 32.

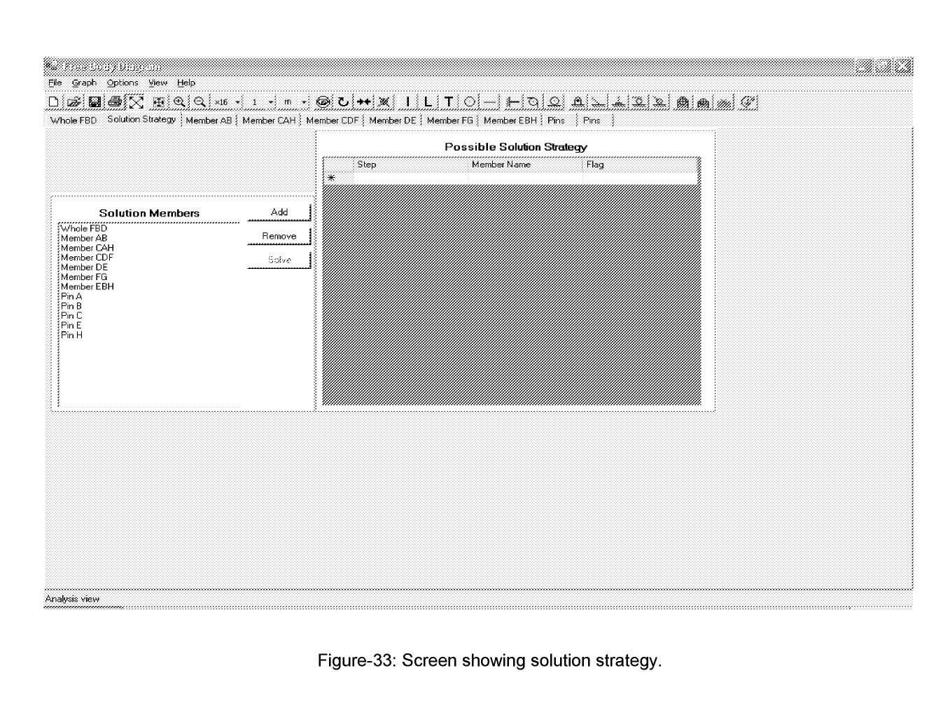

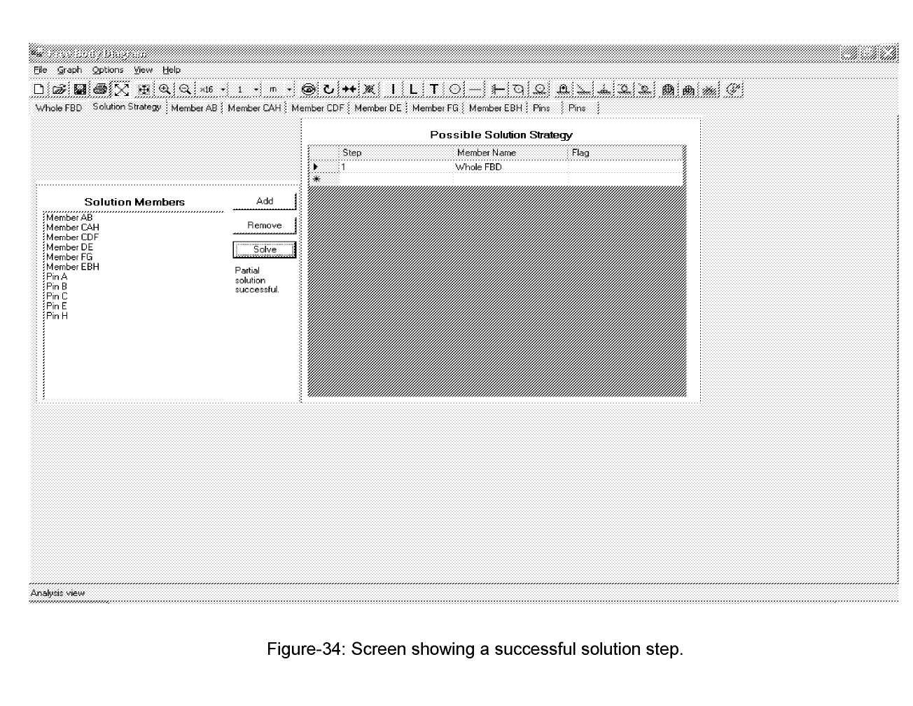

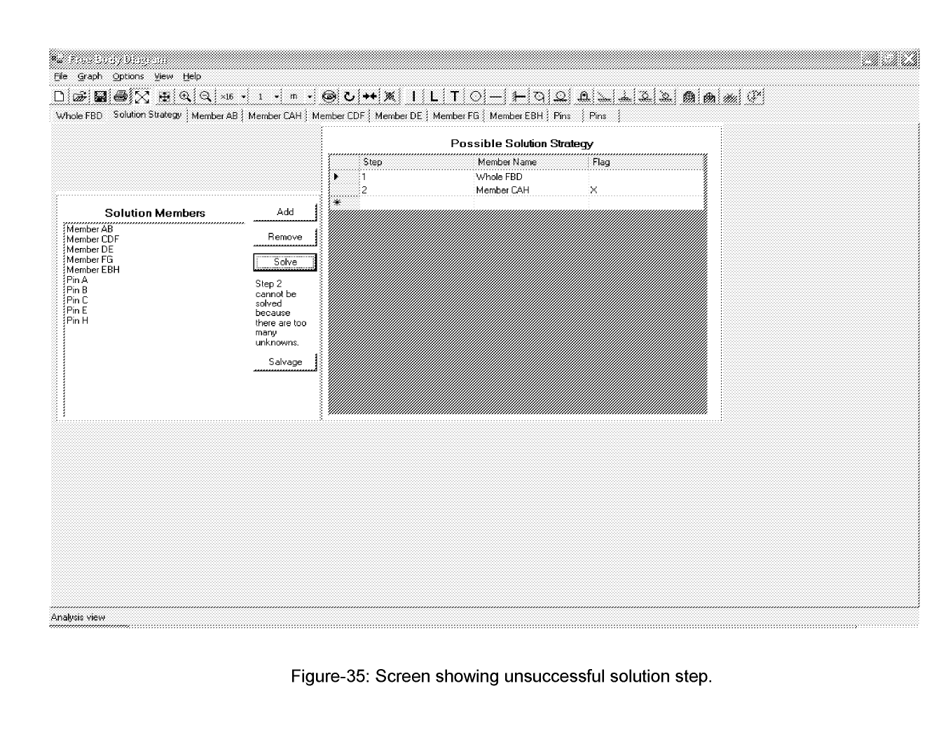

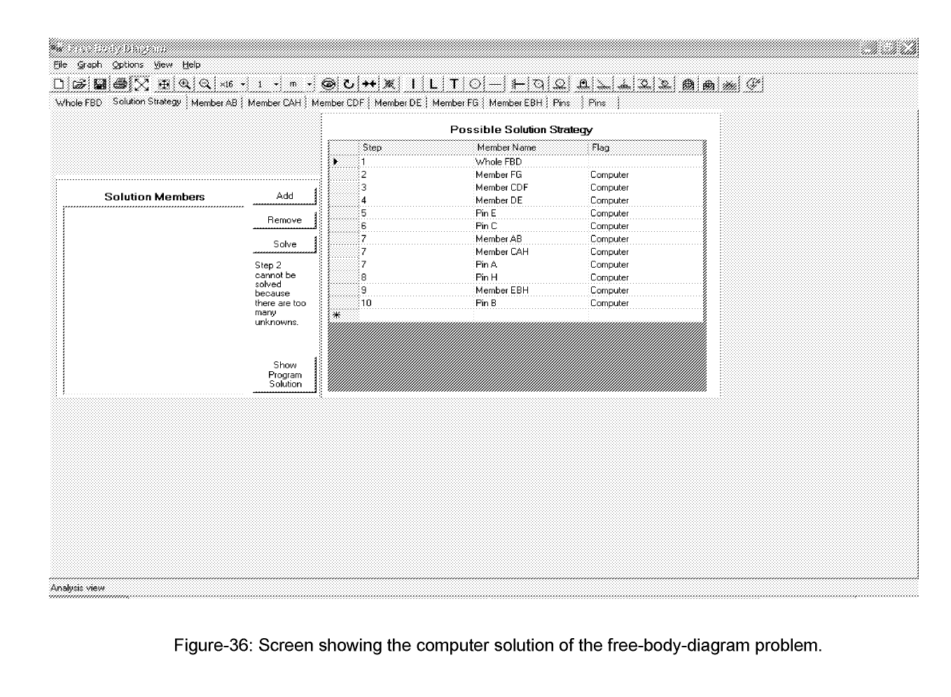

When the user selects the “solution strategy” tab of FIG. 30, the screen of FIG. 33 appears. On this screen, the user can attempt to solve one of the free-body-diagrams listed on the left half of the screen. The analysis included in this solution strategy part is derived from the algorithm covered under the patent application “System and Method for Learning Intervention through Dynamic/Interactive Concept-Mapping”—which was assigned the U.S. patent application Ser. No. 11/259,171, and which is incorporated herein by reference. When the solution is successful, the user gets the screen of FIG. 34; when the solution is unsuccessful, the user gets the screen of FIG. 35. At any time during this solution process, the user can click the “salvage” button, thereby allowing the software to complete the solution. The screen showing the computer solution of the problem is shown in FIG. 36.

In some embodiments, the present invention provides a computer-implemented method that includes graphically displaying a plurality of concepts, wherein the concepts include at least one concept selected from FORCE, MOMENT, COUPLE, FREE-BODY-DIAGRAM, FRAME, TRUSS, MACHINES, EQUILIBRIUM, CENTROID, MOMENT OF INERTIA, SHEAR DIAGRAM, BENDING MOMENT DIAGRAM, FLEXURE, SUPPORT AND INTERNAL REACTIVE FORCES, INTERNAL STRESSES, and STRUCTURAL ELEMENTS. Some embodiments of this method further include posing a problem using a plurality of interactive drawing tools; selecting at least one input variable from an input variable list; and selecting at least one output variable from an output variable list. Some embodiments further include providing a user with a choice to select the path to obtain the solution of a problem; testing the feasibility of a path selected by the user; determining the feasibility of a path and whether the feasibility is positive or negative; and if the path has a negative feasibility, then eliminating the path from consideration in the determination of the effective path and iteratively determining a next effective path.

Some embodiments further include providing a user with input boxes to enter numerical solutions for intermediate steps and final step; testing the correctness of user input; and providing feedback to the user about correctness.

Some embodiments further include graphically displaying (i.e., drawing on a computer display device) sketches and diagrams that are standard among engineers in posing problems; graphically displaying of sketches and diagrams that facilitate problem solving; and graphically displaying sketches and diagrams that show and display the final solution of a problem.

Some embodiments further include making the method of problem solving a part of a learning intervention; embedding the user in a structured environment for mastering new concepts, engaging the user in interactive problem solving; providing the user with feedback to explore new paths toward problem solving; providing the user with feedback to correct user's mistakes in intermediate steps; and developing user's ability to solve new problems.

Some embodiments further include interfacing to an internet in order to provide a service deliverable to and accessible by a user through the internet.

In some embodiments, the present invention provides a computer-readable medium having instructions thereon for causing a suitably programmed information-processing apparatus to perform a method of problem solving comprising: graphically displaying a plurality of concepts, wherein the concepts include at least one concept selected from FORCE, MOMENT, COUPLE, FREE-BODY-DIAGRAM, FRAME, TRUSS, MACHINES, EQUILIBRIUM, CENTROID, MOMENT OF INERTIA, SHEAR DIAGRAM, BENDING MOMENT DIAGRAM, FLEXURE, SUPPORT AND INTERNAL REACTIVE FORCES, INTERNAL STRESSES, and STRUCTURAL ELEMENTS.

In some embodiments, the instructions on the computer-readable medium also cause the method to include posing a problem using a plurality of interactive drawing tools; selecting at least one input variable from an input variable list; and selecting at least one output variable from an output variable list.

In some embodiments, the instructions on the computer-readable medium also cause the method to include providing a user with a choice to select the path to obtain the solution of a problem; testing the feasibility of a path selected by the user; determining the feasibility of a path and whether the feasibility is positive or negative; and if the path has a negative feasibility, then eliminating the path from consideration in the determination of the effective path and iteratively determining a next effective path.

In some embodiments, the instructions on the computer-readable medium also cause the method to include providing a user with input boxes to enter numerical solutions for intermediate steps and final step; testing the correctness of user input; and providing feedback to the user about correctness.

In some embodiments, the instructions on the computer-readable medium also cause the method to include drawing of sketches and diagrams, those are standard among engineers, in posing problems; drawing of sketches and diagrams that facilitate problem solving; and drawing of sketches and diagrams that show and display the final solution of a problem.

In some embodiments, the instructions on the computer-readable medium also cause the method to include making the method of problem solving a part of a learning intervention; embedding the user in a structured environment for mastering new concepts; engaging the user in interactive problem solving; providing the user with feedback to explore new paths toward problem solving; providing the user with feedback to correct user's mistakes in intermediate steps; and developing user's ability to solve new problems.

In some embodiments, the present invention provides a computerized apparatus that includes an information processing system that is programmed to graphically display a plurality of concepts, wherein the concepts include at least one concept selected from FORCE, MOMENT, COUPLE, FREE-BODY-DIAGRAM, FRAME, TRUSS, MACHINES, EQUILIBRIUM, CENTROID, MOMENT OF INERTIA, SHEAR DIAGRAM, BENDING MOMENT DIAGRAM, FLEXURE, SUPPORT AND INTERNAL REACTIVE FORCES, INTERNAL STRESSES, and STRUCTURAL ELEMENTS.

Some embodiments further include a user-interface device configured to pose a problem using a plurality of interactive drawing tools; and to elicit and receive user input that selects at least one input variable from an input variable list; and that selects at least one output variable from an output variable list.

Some embodiments further include a user-interface device that provides a user with a choice and elicits and receives user input indicating a path selected by the user to obtain the solution of a problem; a tester that tests the path selected by the user and determines a feasibility of the path and whether the feasibility is positive or negative; and a module that, if the path has a negative feasibility, eliminates the user-selected path from consideration in the determination of the effective path and iteratively determines a next effective path.

Some embodiments further include a user-interface device that elicits and receives user input indicating user-proposed numerical solutions for intermediate steps and a final step; a tester that tests correctness of the user input; and a module that provides feedback to the user about correctness.

Some embodiments further include a display driver that outputs sketches and diagrams that are standard among engineers in posing problems, sketches and diagrams that facilitate problem solving; and sketches and diagrams that show and display a final solution of a problem.

Some embodiments of this apparatus further include means for posing a problem using a plurality of interactive drawing tools; means for selecting at least one input variable from an input variable list; and means for selecting at least one output variable from an output variable list.

Some embodiments of this apparatus further include means for providing a user with a choice to select the path to obtain the solution of a problem; means for testing the feasibility of a path selected by the user; means for determining the feasibility of a path and whether the feasibility is positive or negative; and means, if the path has a negative feasibility, for eliminating the path from consideration in the determination of the effective path and iteratively determining a next effective path.

Some embodiments of this apparatus further include means for providing a user with input boxes to enter numerical solutions for intermediate steps and final step; means for testing the correctness of user input; and means for providing feedback to the user about correctness.

Some embodiments of this apparatus further include means for drawing of sketches and diagrams that are those which are standard among engineers in posing problems; means for drawing of sketches and diagrams that facilitate problem solving; and means for drawing of sketches and diagrams that show and display the final solution of a problem.

Some embodiments of this apparatus further include means for making the method of problem solving a part of a learning intervention; means for embedding the user in a structured environment for mastering new concepts; means for engaging the user in interactive problem solving; means for providing the user with feedback to explore new paths toward problem solving; means for providing the user with feedback to correct user's mistakes in intermediate steps; and means for developing user's ability to solve new problems.

Some embodiments further include an internet interface operatively coupled to the information processing system and configured to provide a service deliverable to and accessible by a remote user through the internet.

In some embodiments, the present invention provides a computerized method for providing a service deliverable and accessible through the internet. This method includes graphically displaying a plurality of concepts, wherein the concepts include at least one concept selected from FORCE, MOMENT, COUPLE, FREE-BODY-DIAGRAM, FRAME, TRUSS, MACHINES, EQUILIBRIUM, CENTROID, MOMENT OF INERTIA, SHEAR DIAGRAM, BENDING MOMENT DIAGRAM, FLEXURE, SUPPORT AND INTERNAL REACTIVE FORCES, INTERNAL STRESSES, and STRUCTURAL ELEMENTS. Some embodiments further include posing a problem using a plurality of interactive drawing tools; selecting at least one input variable from an input variable list; and selecting at least one output variable from an output variable list. Some embodiments further include providing a user with a choice to select the path to obtain the solution of a problem; testing the feasibility of a path selected by the user; determining the feasibility of a path and whether the feasibility is positive or negative; and, if the path has a negative feasibility, then eliminating the path from consideration in the determination of the effective path and iteratively determining a next effective path. Some embodiments further include providing a user with input boxes to enter numerical solutions for intermediate steps and final step; testing the correctness of user input; and providing feedback to the user about correctness. Some embodiments further include graphically displaying sketches and diagrams, those are standard among engineers, in posing problems; graphically displaying sketches and diagrams that facilitate problem solving; and graphically displaying sketches and diagrams that show and display the final solution of a problem. Some embodiments further include making the method of problem solving a part of a learning intervention; embedding the user in a structured environment for mastering new concepts; engaging the user in interactive problem solving; providing the user with feedback to explore new paths toward problem solving; providing the user with feedback to correct user's mistakes in intermediate steps; and developing user's ability to solve new problems.

### REFERENCES

1. Bransford, J. D., Brown, A. L., Cocking, R., 1999, Knowledge-based cognition and performance assessment in the science classroom, Educational Psychologist, V-31, pp. 133-140.
2. Haskell, R. E., 2001, Transfer of Learning, Academic Press, San Diego.
3. Mayer, R. E., Wittrock, M. C., 1996, Problem-solving transfer, Handbook of Educational Psychology, D. C. Berlinger & R. C. Calfee (Eds.), Macmillan, New York.
4. Roseli, R. J., Cinnamon, B., Norris, P., Brophy, S. P., Eggers, D., Brock, J., 2002, Development of an interactive free body diagram assistant for biomechanics, Proceedings of the 2nd Joint EMBS/BMES Conference, Houston, Tex.

Each of the references listed herein is incorporated by reference.

It is to be understood that the above description is intended to be illustrative, and not restrictive. For example, the same software may have two versions—(i) Educational and (ii) Commercial. In some embodiments, the Educational Version does not include numerical solutions of the problems, whereas in some embodiments, the commercial version calculates the numerical values of the reaction forces at the pins and also the loadings and stresses at a cut on any member of a structure. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A computer-implemented method for learning and teaching engineering statics, the method comprising:
graphically displaying on a computer display device a plurality of computerized tools for concepts of engineering statics, wherein the concepts include FORCE, MOMENT, COUPLE, AREA, LOCATION OF CENTROID OF THE AREA, MOMENT OF INERTIA, SHEAR DIAGRAM, BENDING MOMENT DIAGRAM, and INTERNAL STRESSES;
wherein for a first area the method includes:
eliciting and receiving into the computer user input of a plurality of equations that define a shape of the first area in a coordinate system,
calculating and outputting by the computer on the computer display device, a drawing of the first area, a numerical value for size of the first area, a numerical location of a centroid of the first area, and a numerical value for moment of inertial of the first area,
eliciting and receiving into the computer user input of a shift in origin and an angle of rotation of the coordinate system, and
calculating and outputting by the computer on the computer display device, moment of inertia of the first area in the shifted and rotated coordinate system;
wherein for a first beam system the method includes:
eliciting and receiving into the computer user input that indicates a selection of a first beam having an input beam parameter,
eliciting and receiving into the computer user input that indicates a selection of a first beam support having a type and a location,
eliciting and receiving into the computer user input that indicates a selection of a first load on the first beam, the first load having a type, a location, and a direction,
calculating and outputting by the computer on the computer display device, a drawing of the first beam, a drawing of the first beam support, and a drawing of the first load on the first beam,
outputting on the computer display device by the computer a shear diagram of the first beam system, and
outputting on the computer display device by the computer a bending moment diagram of the first beam system; and
wherein for a free-body diagram of a first structure the method includes:
outputting on the computer display device graphical representations of a plurality of structural-element members including an “I”-shaped member, a “L”-shaped member, a “T”-shaped member, pins, a cable and a pulley,
eliciting and receiving into the computer user input that indicates a selection of a first one, a second one and a third one of the plurality of structural-element members for the first structure,
eliciting and receiving into the computer user input that indicates a distortion and an incline to apply to the first member and a distortion and an incline to apply to the second member,
eliciting and receiving into the computer user input that indicates a support of the first member,
eliciting and receiving into the computer user input that indicates a pin joining between the first member and the second member and a pin joining between the second member and the third member,
applying a plurality of loadings to the first structure by the computer, and
calculating and outputting by the computer on the computer display device, a drawing of the loaded first structure including the joined first member, second member and third member.

2. The method of claim 1, further comprising:
displaying on the computer display device a plurality of input boxes to enter numerical solutions for intermediate steps and final step;
testing the correctness of user input; and
providing feedback to the user about correctness.

3. The method of claim 1, further comprising:
graphically displaying a diagram for posing a problem;
graphically displaying a diagram for problem solving of the problem; and
graphically displaying a diagram for display a final solution of the problem.

4. The method of claim 1, further comprising:
interfacing to an internet in order to provide a service deliverable to and accessible by a user through the internet.

5. The method of claim 1, further comprising:
graphically displaying a control tool and a table for specifying into the computer a size, a location and an orientation of the first, second and third structural-element members, and a magnitude, orientation, and direction of the first load.

6. The method of claim 1, wherein the concepts further include FREE-BODY-DIAGRAM OF FRAMES, TRUSSES AND MACHINES.

7. The method of claim 6, wherein the computerized tools further include STRUCTURAL ELEMENTS.

8. A non-transitory computer-readable medium having instructions thereon for causing a suitably programmed information-processing apparatus to perform a computer-implemented method for learning and teaching engineering statics, the method comprising:
graphically displaying on a computer display device a plurality of computerized tools for concepts of engineering statics, wherein the concepts include FORCE, MOMENT, COUPLE, AREA, LOCATION OF CENTROID OF THE AREA, MOMENT OF INERTIA, SHEAR DIAGRAM, BENDING MOMENT DIAGRAM, and INTERNAL STRESSES;
wherein for a first area the method includes:
eliciting and receiving into the computer user input of a plurality of equations that define a shape of the first area in a coordinate system,
calculating and outputting by the computer on the computer display device, a drawing of the first area, a numerical value for size of the first area, a numerical location of a centroid of the first area, and a numerical value for moment of inertial of the first area,
eliciting and receiving into the computer user input of a shift in origin and an angle of rotation of the coordinate system, and
calculating and outputting by the computer on the computer display device, moment of inertia of the first area in the shifted and rotated coordinate system;
wherein for a first beam system the method includes:
eliciting and receiving into the computer user input that indicates a selection of a first beam having an input beam parameter,
eliciting and receiving into the computer user input that indicates a selection of a first beam support having a type and a location,
eliciting and receiving into the computer user input that indicates a selection of a first load on the first beam, the first load having a type, a location, and a direction,
calculating and outputting by the computer on the computer display device, a drawing of the first beam, a drawing of the first beam support, and a drawing of the first load on the first beam,
outputting on the computer display device by the computer a shear diagram of the first beam system, and
outputting on the computer display device by the computer a bending moment diagram of the first beam system; and
wherein for a free-body diagram of a first structure the method includes:
outputting on the computer display device graphical representations of a plurality of structural-element members including an “I”-shaped member, a “L”-shaped member, a “T”-shaped member, pins, a cable and a pulley,
eliciting and receiving into the computer user input that indicates a selection of a first one, a second one and a third one of the plurality of structural-element members for the first structure,
eliciting and receiving into the computer user input that indicates a distortion and an incline to apply to the first member and a distortion and an incline to apply to the second member,
eliciting and receiving into the computer user input that indicates a support of the first member,
eliciting and receiving into the computer user input that indicates a pin joining between the first member and the second member and a pin joining between the second member and the third member,
applying a plurality of loadings to the first structure by the computer, and
calculating and outputting by the computer on the computer display device, a drawing of the loaded first structure including the joined first member, second member and third member.

9. The computer-readable medium of claim 8, wherein the instructions also cause the method to include:
displaying on the computer display device a plurality of input boxes to enter numerical solutions for intermediate steps and final step;
testing the correctness of user input; and
providing feedback to the user about correctness.

10. The computer-readable medium of claim 8, wherein the instructions also cause the method to include:
graphically displaying a diagram for posing a problem;
graphically displaying a diagram for problem solving of the problem; and
graphically displaying a diagram to display a final solution of the problem.

11. The computer-readable medium of claim 8, wherein the instructions also cause the method to include:
making the method of problem solving a part of a learning intervention;
embedding the user in a structured environment for mastering new concepts;
engaging the user in interactive problem solving;
providing the user with feedback to explore new paths toward problem solving;
providing the user with feedback to correct user's mistakes in intermediate steps; and
developing user's ability to solve new problems.

12. The computer-readable medium of claim 8, wherein the instructions also cause the method to include:
graphically displaying a control tool and a table for specifying into the computer a size, a location and an orientation of the first, second and third structural-element members, and a magnitude, orientation, and direction of the first load.

13. The computer-readable medium of claim 8, wherein the instructions also cause the method to include concepts that further include FREE-BODY-DIAGRAM OF FRAMES, TRUSSES AND MACHINES.

14. The computer-readable medium of claim 13, wherein the instructions also cause the method to include computerized tools that further include STRUCTURAL ELEMENTS.

15. A computerized apparatus for learning and teaching engineering statics, the apparatus comprising:
an information processing system that is programmed to graphically display on a display device a plurality of computerized tools for concepts of engineering statics, wherein the concepts include FORCE, MOMENT, COUPLE, AREA, LOCATION OF CENTROID OF THE AREA, MOMENT OF INERTIA, SHEAR DIAGRAM, BENDING MOMENT DIAGRAM, and INTERNAL STRESSES;
wherein for a first area:
the information processing system is programmed to elicit and receive, into the information processing system, user input of a plurality of equations that define a shape of the first area in a coordinate system,
the information processing system is programmed to calculate and output on the display device, a drawing of the first area, a numerical value for size of the first area, a numerical location of a centroid of the first area, and a numerical value for moment of inertial of the first area,
the information processing system is programmed to elicit and receive, into the information processing system, user input of a shift in origin and an angle of rotation of the coordinate system, and
the information processing system is programmed to calculate and output on the display device, moment of inertia of the first area in the shifted and rotated coordinate system;
wherein for a first beam system:
the information processing system is programmed to elicit and receive, into the information processing system, user input that indicates a selection of a first beam having an input beam parameter,
the information processing system is programmed to elicit and receive, into the information processing system, user input that indicates a selection of a first beam support having a type and a location,
the information processing system is programmed to elicit and receive, into the information processing system, user input that indicates a selection of a first load on the first beam, the first load having a type, a location, and a direction,
the information processing system is programmed to calculate and output on the display device, a drawing of the first beam, a drawing of the first beam support, and a drawing of the first load on the first beam,
the information processing system is programmed to output on the display device a shear diagram of the first beam system, and
the information processing system is programmed to output on the display device a bending moment diagram of the first beam system; and
wherein for a free-body diagram of a first structure:
the information processing system is programmed to output on the display device graphical representations of a plurality of structural-element members including an “I”-shaped member, a “L”-shaped member, a “T”-shaped member, pins, a cable and a pulley,
the information processing system is programmed to elicit and receive, into the information processing system, user input that indicates a selection of a first one, a second one and a third one of the plurality of structural-element members for the first structure,
the information processing system is programmed to elicit and receive, into the information processing system, user input that indicates a distortion and an incline to apply to the first member and a distortion and an incline to apply to the second member,
the information processing system is programmed to elicit and receive, into the information processing system, user input that indicates a support of the first member,
the information processing system is programmed to elicit and receive, into the information processing system, user input that indicates a pin joining between the first member and the second member and a pin joining between the second member and the third member,
the information processing system is programmed to apply a plurality of loadings to the first structure by the information processing system, and
the information processing system is programmed to calculate and output on the display device, a drawing of the loaded first structure including the joined first member, second member and third member.

16. The apparatus of claim 15, further comprising:
a user-interface device that elicits and receives user input indicating user-proposed numerical solutions for intermediate steps and a final step;
a computerized tester that tests correctness of the user input; and
a computerized module that provides feedback to the user about correctness.

17. The apparatus of claim 15, further comprising:
a display driver that outputs sketches and diagrams for posing problems, sketches and diagrams that facilitate problem solving; and sketches and diagrams that show and display a final solution of a problem.

18. The apparatus of claim 15, further comprising:
an internet interface operatively coupled to the information processing system and configured to provide a service deliverable to and accessible by a remote user through the internet.

19. The apparatus of claim 15, wherein the information processing system is programmed to graphically display on the display device a control tool and a table to specify into the information processing system a size, a location and an orientation of the first, second and third structural-element members, and a magnitude, orientation, and direction of the first load.

20. The apparatus of claim 15, wherein the concepts further include FREE-BODY-DIAGRAM OF FRAMES, TRUSSES AND MACHINES, and wherein the computerized tools further include STRUCTURAL ELEMENTS.
